(19) United States
(12) Patent Application Publication
(10) Pub. No.: US 2016/0238199 A1
(43) Pub. Date: Aug. 18, 2016

(54) LIGHT BULB WITH LED SYMBOLS

(71) Applicant: Gean Technology Co. Limited, Hong Kong (HK)

(72) Inventors: Chi Keung Yeung, Hong Kong (HK); Pan Man Wong, Hong Kong (HK); Shan Mei Wan, Hong Kong (HK)

(21) Appl. No.: 15/044,122

(22) Filed: Feb. 16, 2016

Related U.S. Application Data
(60) Provisional application No. 62/116,562, filed on Feb. 16, 2015.

(51) Int. Cl. F21K 99/00; F21V 29/70; G09F 13/22; F21V 23/06; F21V 3/04; F21V 31/00

(52) U.S. Cl. CPC F21K 9/1355; F21V 3/049; F21V 31/00; G09F 13/22; F21V 23/06; F21K 9/90; F21V 29/70; G09F 2013/222; F21Y 2101/02; F21Y 2105/003

(57) ABSTRACT

A light bulb with LED symbols includes a light bulb shell, at least one LED light source, a driver, and an electrical connector. The LED light source includes electrodes and at least one LED substrate with LED chips mounted thereon. The LED substrate has a shape of a pattern, letter, word, logo, character or sign. The LED light source is housed inside a vacuum sealed chamber. The electrodes are connected to a pair of electrical wires, which are connected to a driver and an electrical connector. A method of manufacturing the light bulb is also disclosed.

### CROSS-REFERENCE TO RELATED APPLICATIONS

This application claims the benefit of U.S. Provisional Patent Application No. 62/116,562, filed Feb. 16, 2015, the entire content of which is hereby incorporated by reference.

### FIELD OF THE TECHNOLOGY

The present application relates to a light bulb with light-emitting diode (LED) symbols.

### BACKGROUND

In old times, incandescent light bulb is a major lighting equipment. But its efficiency is low. Lots of energy is wasted in the form of heat.

So, the global trend of the lighting equipment is from incandescent bulb to compact fluorescent light (CFL) bulb, and then to LED bulb. However, the CFL bulb includes mercury which is toxic and LED bulb is most energy efficient.

Referring to FIG. 1, at present, most LED light bulbs are developed for general lighting purpose, where brightness is the main concern for consumers.

On the other hand, there are still some special designs of LED light bulbs or lighting fixtures which provide only decorative purpose, as shown in FIG. 2. However, their LED light sources are large, bulky and having big discrete bright spots (light glare), which make them not beautiful enough.

The above description of the background is provided to aid in understanding the light bulb with LED symbols, but is not admitted to describe or constitute pertinent prior art to the light bulb with LED symbols, or consider any cited documents as material to the patentability of the claims of the present application.

### SUMMARY

According to one aspect, there is provided a light bulb with LED symbols which may include a light bulb shell, at least one LED light source, a driver, and an electrical connector. The LED light source may include at least one LED substrate with a plurality of LED chips mounted thereon, and the at least one LED substrate has a shape of a pattern, letter, word, logo, character or sign. The light bulb shell can be vacuum sealed so as to form a vacuum sealed chamber, which is filled with a gas having a low coefficient of viscosity and a high coefficient of thermal conductivity. The LED light source can be housed in the vacuum sealed chamber, and the LED light source may be electrically connected to the driver via a pair of electrical wires. The driver can be connected to the electrical connector.

The light bulb with LED symbols may further include a core column with an exhaust tube and a bracket. The bracket of the core column may be housed in the vacuum sealed chamber and may hold the pair of electrical wires for fixing the LED light source. The LED light source may include first and second electrodes which are electrically connected to the driver and the electrical connector disposed outside of the vacuum sealed chamber via the electrical wires.

In one embodiment, the light bulb shell is capable of transmitting light and connected to the electrical connector directly or by a connecting piece.

In one embodiment, each LED light source may include at least one series of LED chips connected in series or in parallel. The LED chips may be connected to the first and second electrodes at two ends of the LED light source.

In one embodiment, the at least one LED substrate may be transparent, semi-transparent or non-transparent, and may be made of a material selected from a group consisting of metal, soft glass, hard glass, quartz glass, transparent ceramic and plastic.

In one embodiment, the at least one LED substrate and the LED chips may be partly or thoroughly coated with a phosphor coating.

In one embodiment, the at least one LED substrate can be formed into a 3-dimensional shape.

In one embodiment, a plurality of the LED substrates may be connected with each other by a connector and formed into a 2-dimensional or 3-dimensional shape.

In one embodiment, the at least one LED substrate may include a printed circuit, such that the LED chips can be connected with each other through the printed circuit.

In one embodiment, the first electrode may be provided at one end of the LED substrate, and the LED substrate itself acts as the second electrode.

In one embodiment, the LED substrate may be transparent and the LED chips may emit 4π light. The die bonding material for bonding the LED chips to the LED substrate may be transparent.

In one embodiment, the pair of electrical wires may be mounted on a heat releasing part, and the heat releasing part may be connected with the light bulb shell at a lower portion thereof such that the LED light source is fixed inside the light bulb shell via the pair of electrical wires.

In one embodiment, the electrical connector can be any one of the electrical connectors of E40, E27, E26, E14, GU, BX, BA, EP, EX, GY, GX, GR, GZ, and G types of a conventional light bulb.

In one embodiment, the light bulb shell may be transparent, creamy, frosted or colored.

In one embodiment, a part of the light bulb shell may include a reflective layer, or a series of prisms or lens.

In one embodiment, the light bulb shell may have a shape selected from a group consisting of A, G, R, PAR, T, candle, P, PS, BR, ER, and BRL type.

According to another aspect, there is provided a method for manufacturing a light bulb with LED symbols which may include preparing an LED substrate in a shape of a symbol;
fixing a pair of electrodes to two ends of the LED substrate;
fixing a plurality of LED chips onto the LED substrate by a die bonding material, the LED chips being connected to one another and connected to the electrodes by LED connecting wires to form an LED light source;
coating the LED substrate, the LED chips and the LED connecting wires with a photo luminescent powder layer;
connecting the electrodes to a pair of electrical wires such that the LED light source can be fixed onto the electrical wires;
forming a vacuum sealed chamber with the LED light source mounted therein, and filling the vacuum sealed chamber with a gas having a low coefficient of viscosity and a high coefficient of thermal conductivity;
connecting the electrical wires with a driver; and
connecting the driver with an electrical connector by a plurality of driver connecting wires.

The method may further include forming the LED substrate into a 3-diemnsional shape by twisting, bending or pulling.

Although the light bulb with LED symbols is shown and described with respect to certain embodiments, it is obvious that equivalents and modifications will occur to others skilled in the art upon the reading and understanding of the specification. The light bulb with LED symbols in the present application includes all such equivalents and modifications, and is limited only by the scope of the claims.

### BRIEF DESCRIPTION OF THE DRAWINGS

Specific embodiments of the light bulb with LED symbols will now be described by way of example with reference to the accompanying drawings wherein:

FIGS. 1-2 show LED light bulbs of the prior art.

FIG. 3 shows the structure of a light bulb with LED symbols according to an embodiment of the present application.

FIG. 4 shows the structure of an LED light source according to an embodiment of the present application.

FIG. 5 is a cross sectional view of an LED chip being mounted on an LED substrate according to an embodiment of the present application.

FIGS. 6-7 show LED substrates having different shapes.

FIG. 8 shows LED light sources electrically connected to each other by connectors.

FIG. 9 shows the structure of a connector according to an embodiment of the present application.

FIG. 10 shows a light bulb with three LED light sources connect with each other by connectors according to an embodiment of the present application.

FIG. 11 shows the LED light source only having one electrode at one end of the LED substrate and the LED substrate acts as another electrode according to an embodiment of the present application.

FIG. 12 shows an LED substrate in 3-dimensional shape by twisting, bending or pulling.

FIG. 13 shows LED light sources electrically connected to each other by connectors, forming a three-dimensional shape.

FIG. 14 shows the structure of a light bulb with LED symbols according to another embodiment of the present application.

FIG. 15 shows a light bulb shell formed with a series of lens and a reflective layer according to one embodiment of the present application.

FIG. 16 shows a light bulb shell formed with a series of prisms according to one embodiment of the present application.

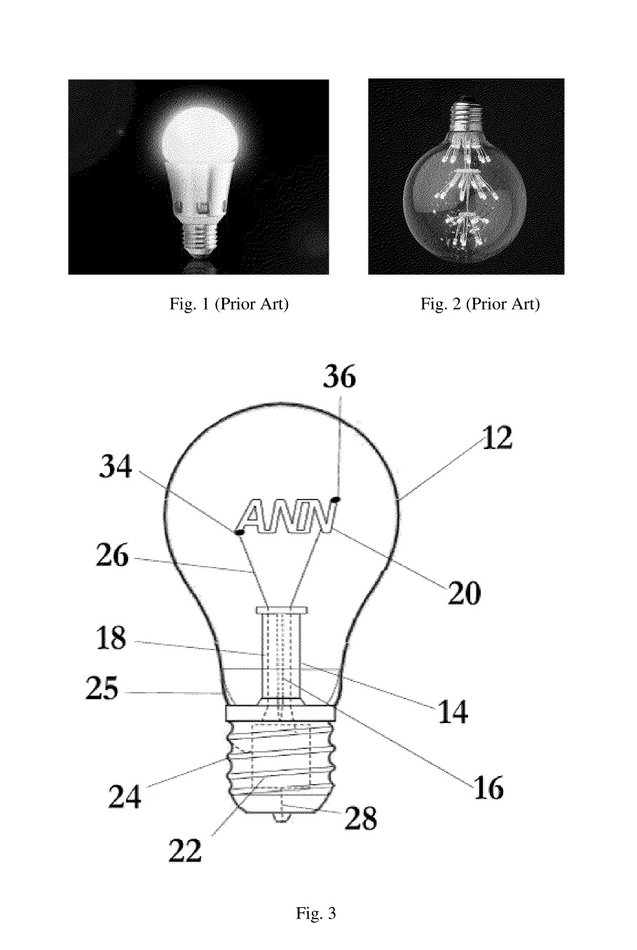

### DETAILED DESCRIPTION

Reference will now be made in detail to a preferred embodiment of the light bulb with LED symbols, examples of which are also provided in the following description. Exemplary embodiments of the light bulb with LED symbols are described in detail, although it will be apparent to those skilled in the relevant art that some features that are not particularly important to an understanding of the light bulb with LED symbols may not be shown for the sake of clarity.

Furthermore, it should be understood that the light bulb with LED symbols is not limited to the precise embodiments described below and that various changes and modifications thereof may be effected by one skilled in the art without departing from the scope of the protection. For example, elements and/or features of different illustrative embodiments may be combined with each other and/or substituted for each other within the scope of this disclosure and appended claims.

In addition, improvements and modifications which may become apparent to persons of ordinary skill in the art after reading this disclosure, the drawings, and the appended claims are deemed within the scope of the protection.

It should be noted that throughout the specification and claims herein, when one element is said to be “coupled” or “connected” to another, this does not necessarily mean that one element is fastened, secured, or otherwise attached to another element. Instead, the term “coupled” or “connected” means that one element is either connected directly or indirectly to another element or is in mechanical or electrical communication with another element.

The present application is to provide a light bulb which contains light-emitting diode (LED) symbols for both general lighting and decorative purposes. As used herein, the term “symbol” includes but is not limited to pattern, letter, word, logo, character and sign. The LED symbols can be very small and can emit light continuously without any light glare.

As shown in FIGS. 3-5, according to an embodiment of the present application, the light bulb with LED symbols may include a light bulb shell 12, a core column 14 with an exhaust tube 16 and a bracket 18, at least one LED light source 20, a driver 22, and an electrical connector 24.

The LED light source 20 may include at least one LED substrate 30 with a plurality of LED chips 32 mounted thereon. The LED substrate 30 may be in the shape of a pattern, letter, word, logo, character, or sign. The LED substrate 30 may be made of metal, soft glass, hard glass, quartz glass, transparent ceramic, plastic, or any other suitable material. The LED substrate 30 may be transparent, semi-transparent or non-transparent. The LED light source 20 may include a first electrode 34 and a second electrode 36.

The LED light bulb shell 12 can be vacuum sealed with the core column 14 so as to form a vacuum sealed chamber, which is filled with a gas having a low coefficient of viscosity and a high coefficient of thermal conductivity. The bracket 18 and the LED light source 20 fixed thereon can be housed in the vacuum sealed chamber.

The LED light source 20 may be electrically connected to the driver 22 via a pair of electrical wires 26. The driver 22 may be in turn connected to the electrical connector 24. The electrical connector 24 may be electrically connected to an external power supply so as to light the LED light source 20.

The first and second electrodes 34, 36 of the LED light source 20 may be connected to the core column 14 via the pair of electrical wires 26 such that the LED light source 20 can be firmly fixed onto the electrical wires 26. The light bulb shell 12 and the core column 14 can be fused at their joining position by high-temperature heating process. Thereafter, they can be vacuum sealed so as to form the vacuum sealed chamber, and the vacuum sealed chamber can be filled with a gas having a low coefficient of viscosity and a high coefficient of thermal conductivity, e.g. He, H₂, or a mixed gas of He and H₂. The driver 22 may be connected to the electrical connector 24 by driver connecting wires 28. The electrical wires 26 of the core column 14 may be connected to the driver 22, and in turn connected to the electrical connector 24. Finally, the electrical connector 24 can be fixed to the light bulb shell 12. The light bulb shell 12 may be connected to the electrical connector 24 directly or by a connecting piece 25.

To manufacture the LED light source 20, the LED substrate 30 in the shape of a symbol is prepared. The electrodes 34, 36 may then be fixed to two ends of the LED substrate 30 by high temperature glue, plastics, sliver slurry, low melting glass or electrode connector. The LED chips 32 may be fixed onto the LED substrate 30 by a die bonding material 33 such as silicon glue, modified resin, epoxy resin or silver epoxy. The LED chips 32 can be connected to one another and connected to the electrodes 34, 36 by LED connecting wires 38. The LED chips 32 can be connected in series or in parallel. Lastly, the LED substrate 30, the LED chips 32 and the LED connecting wires 38 can be partly or thoroughly coated with a photo luminescent powder layer or a phosphor coating 35.

Each LED light source 20 may include at least one series of LED chips 32 connected in series or in parallel. The LED chips 32 may be connected to the electrodes 34, 36 at two ends of the LED light source 20.

The LED substrate 30 may include a printed circuit, such that the LED chips 32 may be connected with one another through the printed circuit.

The LED substrate 30 may be transparent and the LED chips 32 can emit 4π light. The die bonding material 33 for bonding the LED substrate 30 and the LED chips 32 together may be transparent.

As shown in FIGS. 6-7, the LED substrate 30′, 30″ may be of different shapes, e.g. circle, triangle, rectangle, letters, etc.

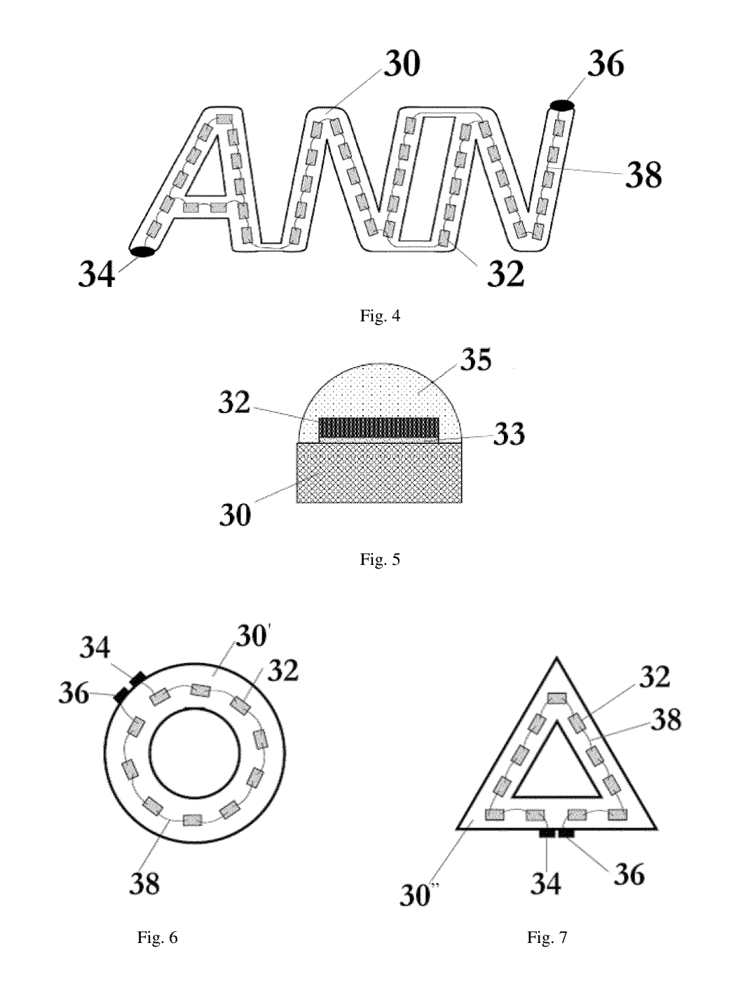

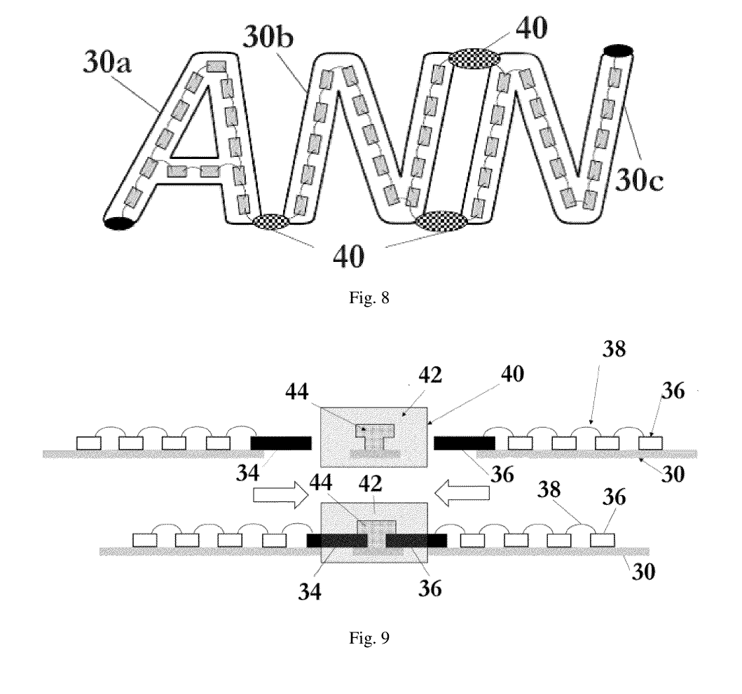

Apart from the integrally formed LED light source 20 in FIGS. 4, 6 and 7, several individual LED light sources 30a, 30b, 30c can be electrically connected to one another using connectors 40 and formed into a 2-dimensional shape, as shown in FIG. 8.

As shown in FIG. 9, the connector 40 may have a plastic (non-conductive) housing 42 and a metal core 44 inside. When the electrodes 34, 36 of the LED light sources 20 are plugged into the connector 40, as shown by the arrows, they can be electrically connected to each other via the metal core 44.

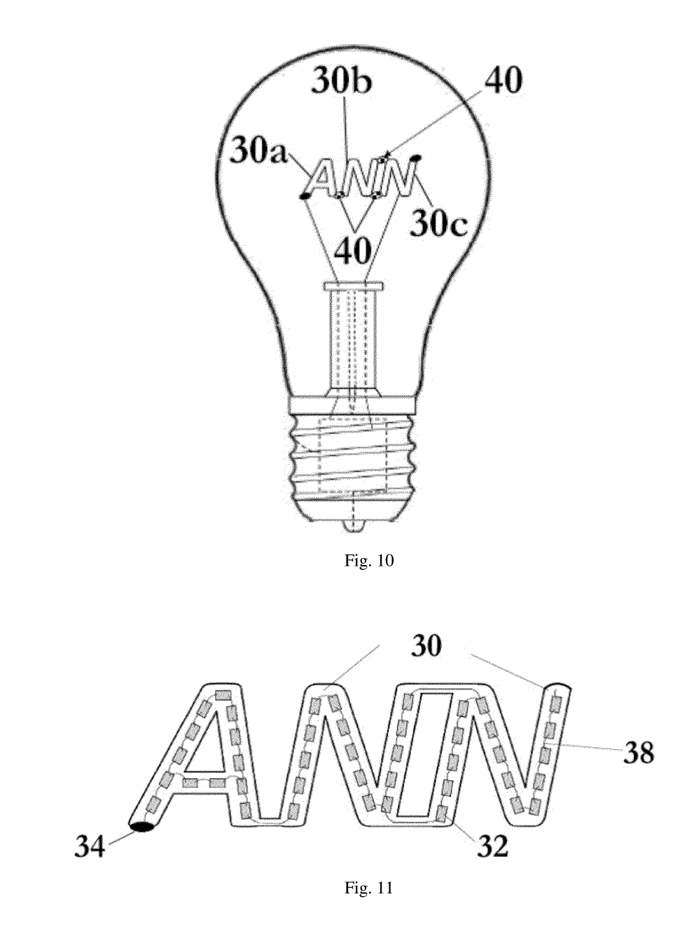

FIG. 10 shows a light bulb with the three LED light sources 30a, 30b, 30c connected together by three connectors 40.

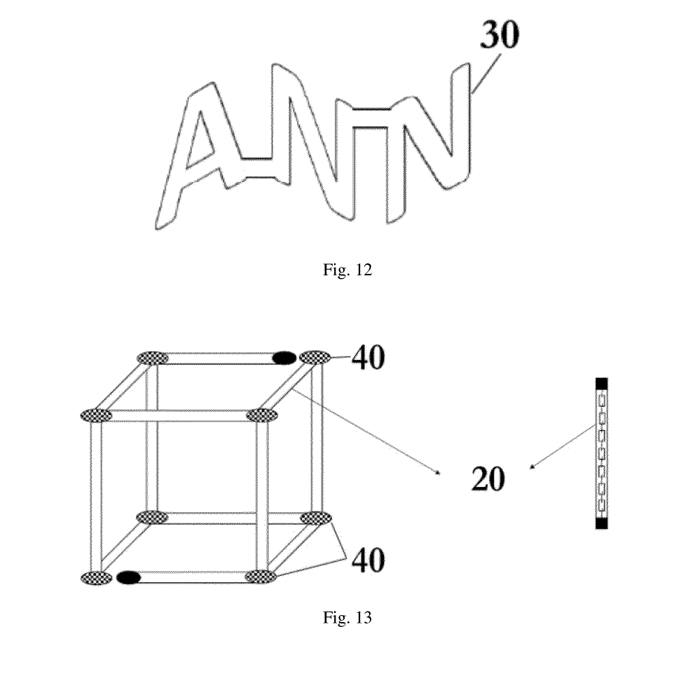

As shown in FIG. 11, the LED light source 20 may have the first electrode 34 provided at one end of the LED substrate 20, and the LED substrate 30 itself can act as the second electrode.

As illustrated in FIG. 12, the LED substrate 30 can be formed into a three-dimensional shape by twisting, bending or pulling.

As shown in FIG. 13, several LED light sources 20 may be electrically connected to one another using connectors 40, and formed into a three-dimensional shape.

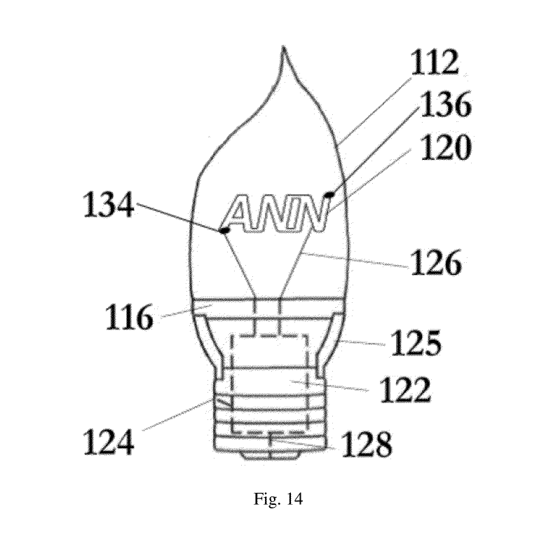

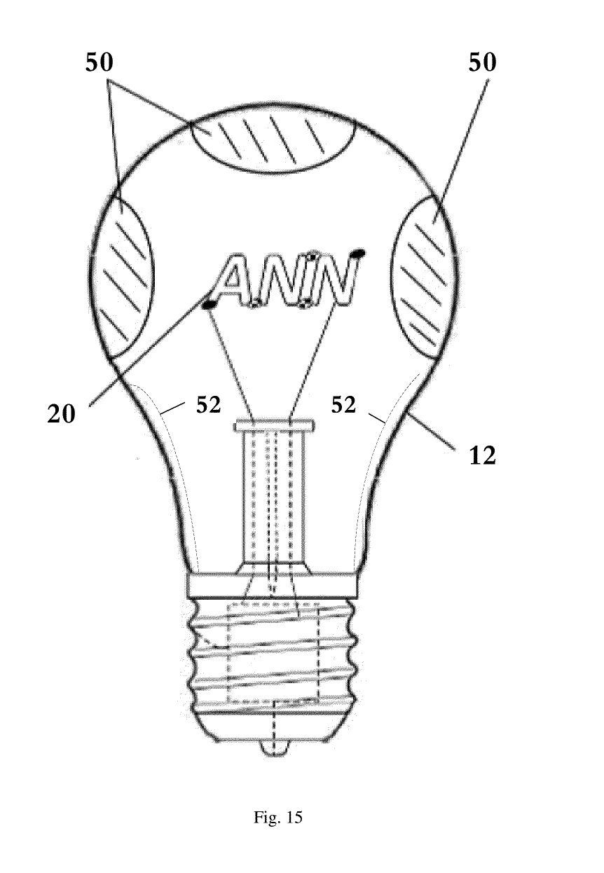

As depicted in FIG. 14, according to another embodiment of the present application, the light bulb with LED symbols may include an LED light source 120 with first and second electrodes 134, 136 at two ends thereof, a heat releasing part 116 with a pair of electrical wires 126, a light bulb shell 112, a driver 122, and an electrical connector 124.

The electrodes 134, 136 of the LED light source 120 can be connected and firmly fixed to the electrical wires 126 of the heat releasing part 116. The pair of electrical wires 126 may be mounted on the heat releasing part 116. The heat releasing part 116 may be connected with the light bulb shell 112 at a lower portion thereof such that the LED light source 120 can be fixed inside the light bulb shell 112 via the pair of electrical wires 126.

The heat releasing part 116 may be made of a material which has high thermal conductivity but electrically non-conductive. The driver 122 may be connected to the electrical connector 124 by driver connecting wires 128. The electrical wires 126 of the heat releasing part 116 may be connected to the driver 122, and in turn connected to the electrical connector 124. Lastly, the electrical connector 124 can be connected to the light bulb shell 112 through a connecting piece 125.

The electrical connector 24, 124 may be any one of the electrical connectors of E40, E27, E26, E14, GU, BX, BA, EP, EX, GY, GX, GR, GZ, and G types of a conventional light bulb.

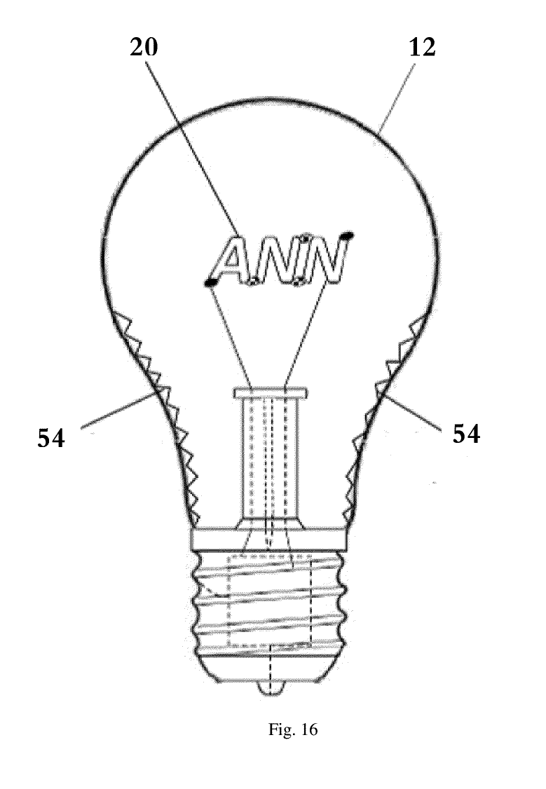

The light bulb shell 12, 112 may be transparent, creamy, frosted or colored. The light bulb shell 12, 112 may have the shape of A, G, R, PAR, T, candle, P, PS, BR, ER, or BRL type. A part of the light bulb shell 12, 112 may have a reflective layer, or a series of small prisms or lens. As illustrated in FIG. 15, the light bulb shell 12 may be formed with a plurality of lens 50 for light refraction. A reflective layer 52 may also be formed on an inner surface of the light bulb shell 12 for reflection of light from the LED light source 20. As illustrated in FIG. 16, the light bulb shell 12 may be formed with a series of prisms 54 for light refraction.

While the light bulb with LED symbols has been shown and described with particular references to a number of preferred embodiments thereof, it should be noted that various other changes or modifications may be made without departing from the scope of the appended claims.

What is claimed is:

1. A light bulb with LED symbols, the light bulb comprising:
a light bulb shell;
a core column with an exhaust tube and a bracket;
at least one LED light source;
a driver; and
an electrical connector,
wherein the LED light source comprises at least one LED substrate with a plurality of LED chips mounted thereon, the at least one LED substrate having a shape of a pattern, letter, word, logo, character or sign,
wherein the LED light source comprises first and second electrodes,
wherein the LED light bulb shell is vacuum sealed with the core column so as to form a vacuum sealed chamber, which is filled with a gas having a low coefficient of viscosity and a high coefficient of thermal conductivity,
wherein the bracket and the LED light source fixed thereon are housed in the vacuum sealed chamber, and
wherein the LED light source is electrically connected to the driver via a pair of electrical wires, the driver being connected to the electrical connector, and the electrical connector being electrically connected to an external power supply so as to light the LED light source.

2. A light bulb with LED symbols, the light bulb comprising:
a light bulb shell;
at least one LED light source;
a driver; and
an electrical connector,
wherein the LED light source comprises at least one LED substrate with a plurality of LED chips mounted thereon, the at least one LED substrate having a shape of a pattern, letter, word, logo, character or sign,
wherein the light bulb shell is vacuum sealed so as to form a vacuum sealed chamber, which is filled with a gas having a low coefficient of viscosity and a high coefficient of thermal conductivity,
wherein the LED light source is housed in the vacuum sealed chamber, and
wherein the LED light source is electrically connected to the driver via a pair of electrical wires, the driver being connected to the electrical connector.

3. The light bulb with LED symbols of claim 2, further comprising a core column with an exhaust tube and a bracket, wherein the bracket of the core column is housed in the vacuum sealed chamber and holding the pair of electrical wires for fixing the LED light source, and the LED light source comprises first and second electrodes which are electrically connected to the driver and the electrical connector disposed outside of the vacuum sealed chamber via the electrical wires.

4. The light bulb with LED symbols of claim 2, wherein the light bulb shell is capable of transmitting light and connected to the electrical connector directly or by a connecting piece.

5. The light bulb with LED symbols of claim 3, wherein each LED light source comprises at least one series of LED chips connected in series or in parallel, the LED chips being connected to the first and second electrodes at two ends of the LED light source.

6. The light bulb with LED symbols of claim 2, wherein the at least one LED substrate is transparent, semi-transparent or non-transparent.

7. The light bulb with LED symbols of claim 2, wherein the at least one LED substrate is made of a material selected from a group consisting of metal, soft glass, hard glass, quartz glass, transparent ceramic and plastic.

8. The light bulb with LED symbols of claim 2, wherein the at least one LED substrate and the LED chips are partly or thoroughly coated with a phosphor coating.

9. The light bulb with LED symbols of claim 2, wherein the at least one LED substrate is formed into a 3-dimensional shape.

10. The light bulb with LED symbols of claim 2, wherein a plurality of the LED substrates is connected with each other by a connector and formed into a 2-diemnsional or 3-dimensional shape.

11. The light bulb with LED symbols of claim 2, wherein the at least one LED substrate comprises a printed circuit, such that the LED chips are connected with each other through the printed circuit.

12. The light bulb with LED symbols of claim 3, wherein the first electrode is provided at one end of the LED substrate, and the LED substrate itself acts as the second electrode.

13. The light bulb with LED symbols of claim 2, wherein the LED substrate is transparent and the LED chips emit 4π light, and wherein a die bonding material for bonding the LED chips to the LED substrate is transparent.

14. The light bulb with LED symbols of claim 2, wherein the pair of electrical wires is mounted on a heat releasing part, and the heat releasing part is connected with the light bulb shell at a lower portion thereof such that the LED light source is fixed inside the light bulb shell via the pair of electrical wires.

15. The light bulb with LED symbols of claim 2, wherein the electrical connector is any one of the electrical connectors of E40, E27, E26, E14, GU, BX, BA, EP, EX, GY, GX, GR, GZ, and G types of a conventional light bulb.

16. The light bulb with LED symbols of claim 2, wherein the light bulb shell is transparent, creamy, frosted or colored.

17. The light bulb with LED symbols of claim 2, wherein a part of the light bulb shell comprises a reflective layer, or a series of prisms or lens.

18. The light bulb with LED symbols of claim 2, wherein the light bulb shell has a shape selected from a group consisting of A, G, R, PAR, T, candle, P, PS, BR, ER, and BRL type.

19. A method for manufacturing a light bulb with LED symbols, the method comprising:
preparing an LED substrate in a shape of a symbol;
fixing a pair of electrodes to two ends of the LED substrate;
fixing a plurality of LED chips onto the LED substrate by a die bonding material, the LED chips being connected to one another and connected to the electrodes by LED connecting wires to form an LED light source;
coating the LED substrate, the LED chips and the LED connecting wires with a photo luminescent powder layer;
connecting the electrodes to a pair of electrical wires such that the LED light source can be fixed onto the electrical wires;
forming a vacuum sealed chamber with the LED light source mounted therein, and filling the vacuum sealed chamber with a gas having a low coefficient of viscosity and a high coefficient of thermal conductivity;
connecting the electrical wires with a driver; and
connecting the driver with an electrical connector by a plurality of driver connecting wires.

20. The method of claim 19, further comprising forming the LED substrate into a 3-diemnsional shape by twisting, bending or pulling.
